(19) United States
(12) Patent Application Publication
(10) Pub. No.: US 2017/0185921 A1
(43) Pub. Date: Jun. 29, 2017

(54) SYSTEM AND METHOD FOR DEPLOYING CUSTOMIZED MACHINE LEARNING SERVICES

(71) Applicant: CLOUDBRAIN INC., Mountain View, CA (US)

(72) Inventor: Benyu Zhang, Mountain View, CA (US)

(73) Assignee: CLOUDBRAIN INC., Mountain View, CA (US)

(21) Appl. No.: 15/388,899

(22) Filed: Dec. 22, 2016

Related U.S. Application Data
(60) Provisional application No. 62/272,027, filed on Dec. 28, 2015.

(51) Int. Cl. G06N 99/00; G06N 5/04; G06F 9/445

(52) U.S. Cl. CPC G06N 99/005; G06F 8/60; G06N 5/04

(57) ABSTRACT

The present disclosure discloses a system and method for deploying customized machine learning services. Specifically, a computing device of a machine learning service provider maintains a meta training component and a plurality of meta data schemas. The computing device also generates a customized data schema based on customization of one of the plurality of meta data schemas by a machine learning service client. Further, the computing device can generate a training component based on the meta training component. The training component is compatible with the customized data schema. Then, the computing device deploys the customized data schema and the training component to one or more client devices to automatically generate a machine learning model.

### CROSS-REFERENCE TO RELATED APPLICATIONS

This application claims the benefit of priority on U.S. Provisional Patent Application No. 62/272,027 filed Dec. 28, 2015, the entire contents of which are incorporated by reference herein.

### FIELD

Embodiments of the present disclosure relate to machine learning technologies. In particular, embodiments of the present disclosure describe a system and a method for deploying customized machine learning services to enterprise computing environments.

### BACKGROUND

Unless otherwise indicated herein, the materials described in this section are not prior art to the claims in this application and are not admitted to be prior art by inclusion in this section.

Many machine learning service providers attempt to provide hosted machine learning services to business clients. Typically, these providers often require the business clients to upload data to the provider's system in order to train and subsequently provide machine learning models to the clients. However, it may be against the clients' policy to upload such sensitive or confidential data to a third-party provider's system.

Moreover, after the machine learning models are downloaded to the clients' system, it may still require customized tuning for each client by a skilled human engineer. For example, different clients may pursue different key performance indices (KPIs). A “KPI” generally refers to a type of performance measurement that evaluates the success of either a particular group of individuals (e.g., organization, department, etc.) or of a particular activity in which the particular group of individuals engages. Also, without standardized data support, a skilled human engineer needs to be involved in tuning the models for diversified data.

Furthermore, conventional machine learning service providers cannot leverage learned knowledge across different client systems. This is because even if a provider is providing a hosted machine learning service to multiple clients on the same machine, the provider cannot use the uploaded data from one client for training the model for another client. Therefore, the hosted data from different clients are isolated from each other and cannot be used to reinforce the machine learning process for each other.

### BRIEF DESCRIPTION OF THE DRAWINGS

The present disclosure may be best understood by referring to the following description and accompanying drawings that are used to illustrate embodiments of the present disclosure.

FIG. 1 is a block diagram illustrating an exemplary environment for providing machine learning services according to conventional prior arts.

FIG. 2 is a block diagram illustrating an exemplary environment for providing machine learning services according to embodiments of the present disclosure.

FIGS. 3A-3C are block diagrams illustrating an exemplary environment for providing machine learning services in details according to embodiments of the present disclosure.

FIG. 4 is a block diagram illustrating an exemplary view of machine learning service deployment between a client and a provider according to embodiments of the present disclosure.

FIG. 5 is a block diagram illustrating exemplary meta data schemas according to embodiments of the present disclosure.

FIG. 6 is a block diagram illustrating an example of how meta data schemas reinforce each other during the machine learning process according to embodiments of the present disclosure.

FIGS. 7A-7B are flowcharts illustrating an exemplary process for providing customized machine learning services according to embodiments of the present disclosure.

FIG. 8 is a block diagram illustrating an exemplary system for providing customized machine learning services according to embodiments of the present disclosure.

### DETAILED DESCRIPTION

In the following description, several specific details are presented to provide a thorough understanding. While the context of the disclosure is directed to machine learning technologies, one skilled in the relevant art will recognize, however, that the concepts and techniques disclosed herein can be practiced without one or more of the specific details, or in combination with other components, etc. In other instances, well-known implementations or operations are not shown or described in detail in order to avoid obscuring aspects of various examples disclosed herein. It should be understood that this disclosure covers all modifications, equivalents, and alternatives falling within the spirit and scope of the present disclosure.

Herein, certain terminology is used to describe various features of the invention. For example, the terms “logic” and “component” are representative of hardware, firmware or software that is configured to perform one or more functions. As hardware, logic (or component) may include circuitry having data processing functionality. Examples of such circuitry may include, but are not limited or restricted to a hardware processor (e.g., microprocessor with one or more processor cores, a digital signal processor, a programmable gate array, a microcontroller, an application specific integrated circuit “ASIC”, etc.), a semiconductor memory, combinatorial circuits, or other types of circuit.

Logic (or component) may be software such as a process, an instance, Application Programming Interface (API), subroutine, function, applet, servlet, routine, source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

The term “computing device” should be construed as any electronic device with the capability of connecting to a network. Such a network may be a public network such as the Internet or a private network such as a wireless data telecommunication network, wide area network, a type of local area network (LAN), or a combination of networks. Examples of a computing device may include, but are not limited or restricted to, a laptop, a smartphone, a tablet, a computer, server, wearable technology, etc.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### Overview

Embodiments of the present disclosure relate to machine learning technologies. In particular, embodiments of the present disclosure describe a system and a method for providing customized machine learning services to enterprise computing environments.

According to embodiments of the present disclosure, a computing device of a machine learning service provider maintains a meta training component and a plurality of meta data schemas. The meta training component operates as a base (general framework) for deriving training components which are able to train models from data. The meta data schemas are the base for deriving data schemas which are responsible for defining and describing the data where models are trained from. The computing device also generates a customized data schema based on the customization of one of the plurality of meta data schemas by a machine learning service client. Further, the computing device can generate a training component based on the meta training component. The meta training component is compatible with the customized data schema. The computing device deploys the customized data schema and the meta training component to one or more client devices to automatically generate a machine learning model.

### Conventional Machine Learning Environment

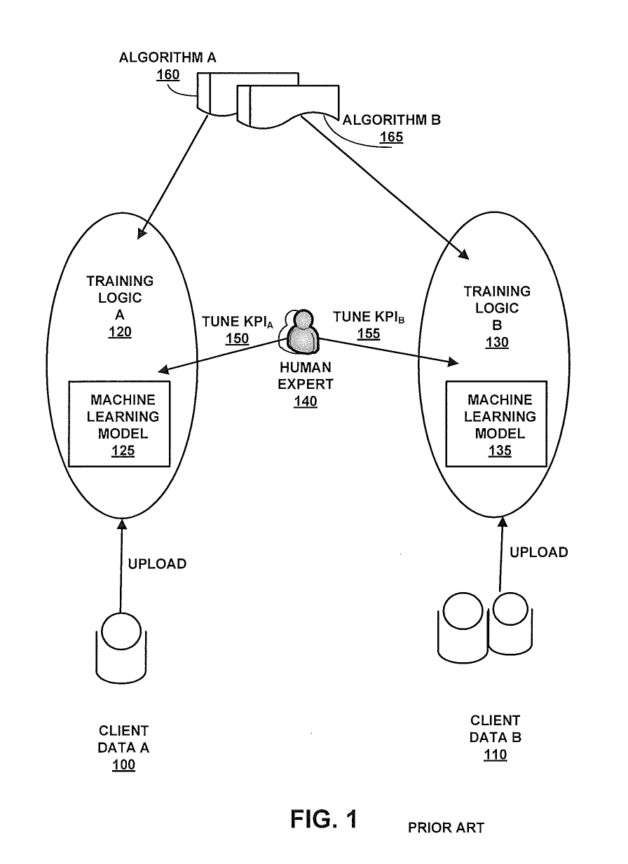

FIG. 1 is a block diagram illustrating an exemplary environment for providing machine learning services according to conventional prior arts. FIG. 1 includes two different sets of client data, namely Client Data A 100 and Client Data B 110 that belong to two different clients or two different departments/divisions/business units of the same client. Here, Client Data A 100 is associated with key performance indicator KPI_{A}, whereas Client Data B 110 is associated with key performance indicator KPI_{B}. As described above, a key performance indicator (KPI) generally refers to a type of performance measurement that evaluates the success of either a particular client (e.g. organization, department, etc.) or of a particular activity in which the client engages. For example, the success may be the repeated, periodic achievement of some levels of operational goal. Sometimes, the success can be defined in terms of making progress toward strategic goals. Accordingly, choosing the right KPIs relies upon a good understanding of what is important to the client. Thus, KPIs are often different among different clients.

Conventionally, Client Data A 100 is uploaded to a training logic A 120, which is adapted to generate a machine learning model 125. The machine learning model 125 is compatible with Client Data A 100. Specifically, the training logic A 120 uses a selected training algorithm 160 (referred to as “Algorithm A”) to generate the machine learning model 125. Furthermore, a human expert 140 needs to tune the machine learning model 125 generated by training logic A 120 to maximize KPI_{A} 150. As an illustrative example, the machine learning model 125 may be configured to maximize the ads click-thru rate which is an important KPI for online monetization.

Likewise, Client Data B 110 is uploaded to a training logic B 130, which is adapted to generate a machine learning model 135 that is compatible with Client Data B 110. Herein, instead of Algorithm A 160, the training logic B 130 uses another selected training algorithm 165 (referred to as “Algorithm B”) to generate the machine learning model 135. It is contemplated that Algorithm B 165 may be the same, similar, or even different from Algorithm A 160. Furthermore, the human expert 140 may tune the machine learning model 135 generated by the training logic B 130 to maximize KPI_{B} 155.

There are several problems associated with this conventional approach. First, clients may not be willing to upload proprietary data, namely Client Data A 100 and Client Data B 110, to a third-party provider. Second, the involvement of the human expert 140 can be very costly, especially for small to medium sized businesses. Lastly, training logic A 120 cannot acquire knowledge learned by training logic B 130 during generation of the machine learning model 135 because (i) the operations by training logic A 120 and training logic B 130 are considered completely separate and isolated processes and (ii) sharing of such results may violate confidentiality and other policies normally insisted by clients. Therefore, it is desirable for an enhanced machine learning system that does not compromise client data security and is more cost-efficient and effective than conventional machine learning systems.

### Customized Machine Learning

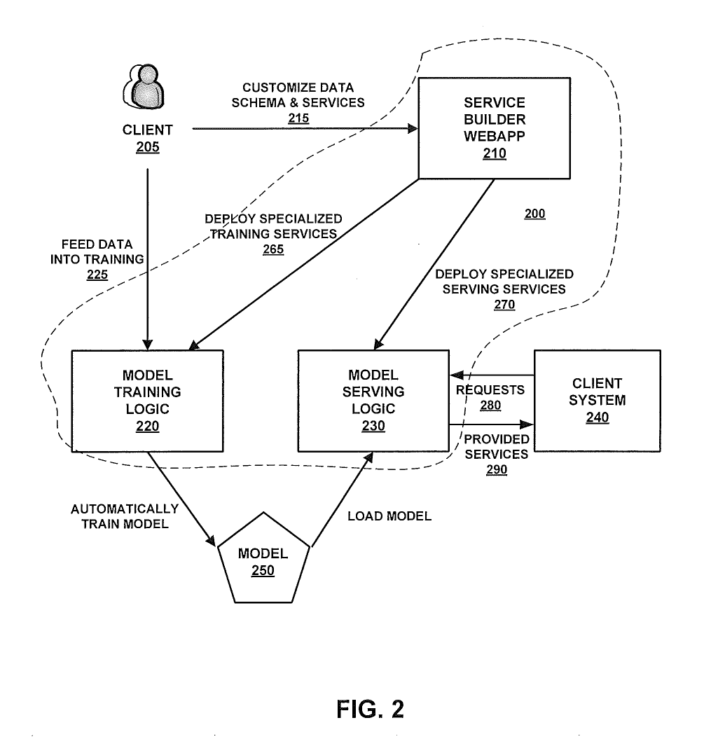

FIG. 2 is a block diagram illustrating an exemplary flow of operations by machine learning system 200 that provides machine learning services. The machine learning system 200 includes, but is not limited to, a service builder web application 210, a model training logic 220 and a model serving logic 230. As shown, a client 205 provides customized data schema 215 to service builder web application 210 and client data 225 to the model training logic 220. In return, a client system 240 receives provided services. The “provided services” may generally operate as a computing Application Programming Interface (API), such as HTTP REST RPC services for example. For instance, the provided services may accept requests of predicting click-thru rates (CTR) of several advertisements for a given user and given context; and then the provided services will return the predicted CTR for the aforementioned advertisements.

Client 205 represents any entity that utilizes machine learning services to improve its business initiatives, for example, as measured by one or more key performance indicators (KPIs). The KPIs may be different for different business clients. For example, for a sales department, KPIs may include sales growth, sales bookings, quote to close ratio, sales target, average profit margin, average purchase value, etc. For a marketing department, KPIs may include return on investment (ROI), keyword performance, email marketing engagement score, social sentiment, etc. For a call center, KPIs may include average call handling time, client satisfaction, call resolution rate, etc.

The service builder web application 210 generally refers to a web application hosted by the machine learning system 200 to provide machine learning services for its clients. According to one embodiment of the disclosure, the service builder web application 210 predefines a number of meta data schemas that are supported by the machine learning services Specifically, in communication with service builder web application 210, the client 205 selects a meta data schema from a plurality of meta data schemas supported by the machine learning system 200, and a customized data schema 215 is generated based on the selected meta data schema. The customized data schema 215 is a more detailed version of the selected meta data schema that is based on proprietary data at client 205, which may be generated manually or automatically through a computer program. The selection of the meta data schema may be based, at least in part, on a particular service that the client 205 consumes. Communications between the client 205 and the service builder web application 210 may be accomplished via an user interface provided by the service builder web application 210.

Thereafter, the client 205 may convert its own proprietary data into client training data 225 using customized data schema 215, and thus, the client training data 225 is compatible with the customized data schema 215. As long as the client training data 225 is compatible with the customized data schema 215 (and hence the meta data schema), the machine learning system 200 can have a unified view of diversified data, and thus can automatically tune the client training data 225 to generate a machine learning model 250. Thereby, the machine learning system 200 eliminates the need for an on-site human expert to tune the client data.

The model training logic 220 generally trains models for the machine learning system 200. Specifically, the service builder web application 210 can deploy specialized training services 265 to activate and control operations of the model training logic 220 for training model 250. Moreover, after converting its own proprietary data into client training data 225 that is compatible with the customized data schema 215, the client 205 can feed such client training data 225 into the model training logic 220. Specialized training services 265 may include one or more training component binary files that are specific to client training data 225. After receiving the client training data 225 from client 205 and the specialized training services 265 from the service builder web application 210, the model training logic 220 automatically trains model 250. The model 250 generated by the model training logic 220 is then loaded into the model serving logic 230.

The model serving logic 230 generally receives requests from business clients, loads machine learning models, and provides services to client systems. Specifically, the service builder web application 210 can deploy specialized serving services 270, including one or more serving component binary files that are specific to client training data 225, to the model serving logic 230. The model serving logic 230 receives requests 280 from business clients. Next, the model serving logic 230 will select one or more models based on the received requests 280. Then, the model serving logic 230 will load the selected models and provide services 290 to the client system 240.

The client system 240 generally refers to an enterprise computing environment that is operated and/or used by client 205. Herein, the client system 240 may include a very large volume of proprietary client data that is diverse, sensitive, and/or personal. Such diverse client data provides valuable information or guidance on how a business may improve its key performance indicators (KPIs). For example, the client system 240 may be a social networking platform, an online banking system, an online shopping network, a news portal, a gaming platform, a streaming video/data repository, etc.

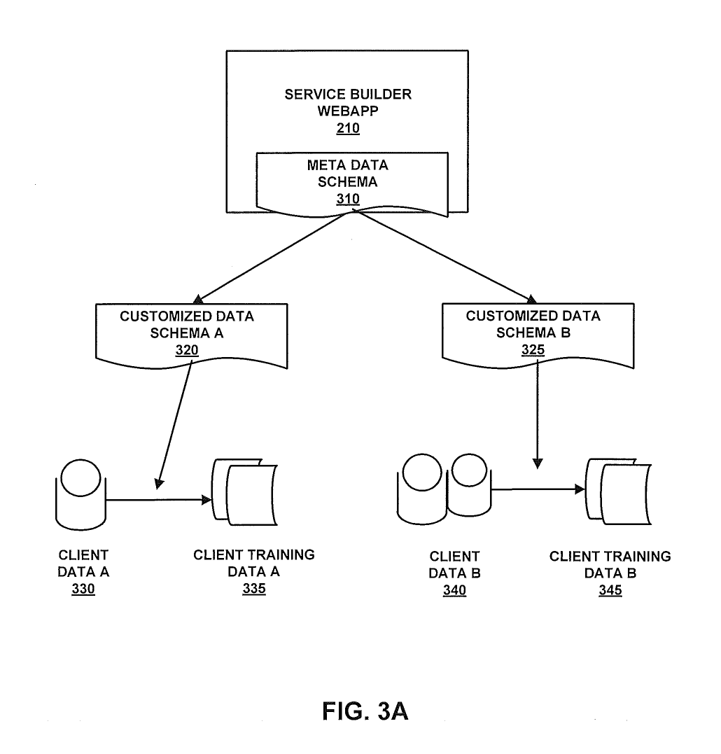

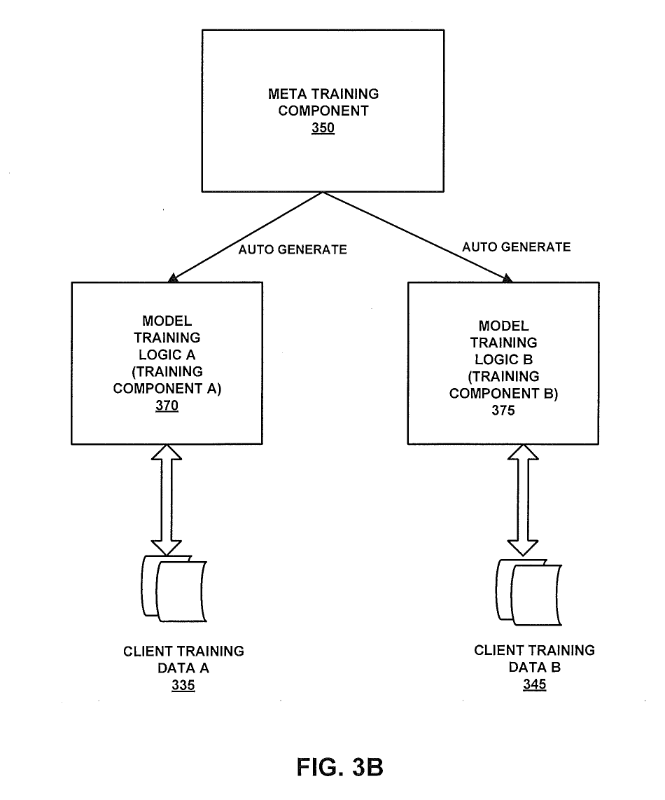

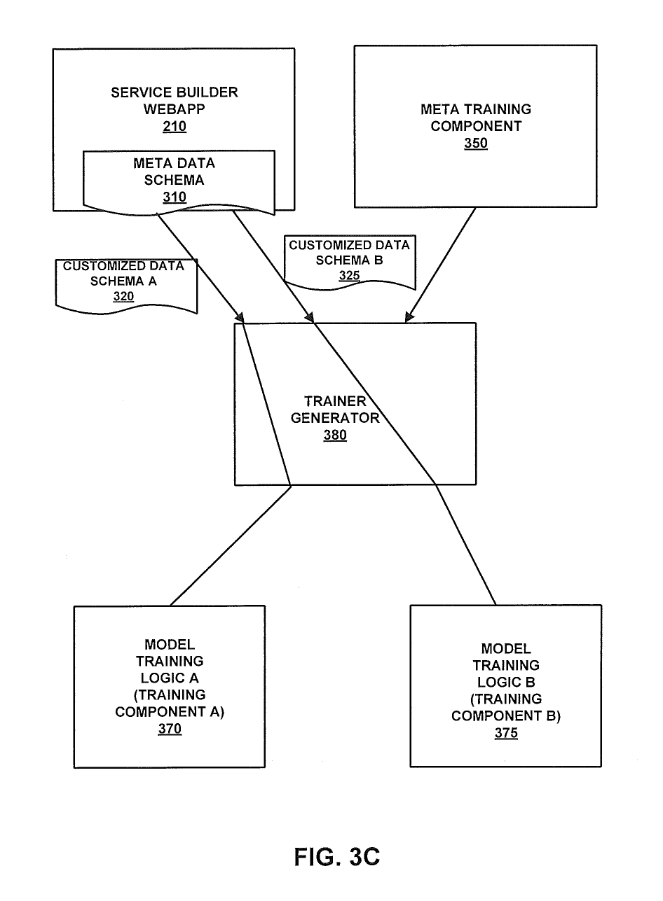

FIGS. 3A-3C are block diagrams illustrating an exemplary environment for providing machine learning services in details according to embodiments of the present disclosure.

A. Service Builder Web Application

In particular, FIG. 3A is an exemplary block diagram illustrating the service builder web application 210 for providing machine learning services according to embodiments of the present disclosure. Herein, the service builder web application 210 includes one or more meta data schema 310 (illustrated as “meta data schema”). A first client, which owns client data A 330, can select a meta data schema 310, and generate a customized data schema A 320 based on the selected meta data schema 310. According to one embodiment of the disclosure, the customized data schema A 320 may be generated based, at least in part on first client use of an online interface provided by service builder web application 210. Likewise, a second client, which owns client data B 340, can select the same meta data schema 310 using the same online interface provided by the service builder web application 300 in order to generate a customized data schema B 325. Herein, the customized data scheme B 325 is based, at least in part, on the selected meta data schema 310 and may differ from the customized data schema A 320. Also, client data A 330 is diverse from client data B 340 with different data schemas that are incompatible with each other.

The first client can then convert client data A 330 to client training data A 335 that follows the customized data schema A 320. As client data 330 may be raw data provided from the first client, the client training data A 335 is converted by, for example, removal, addition and/or transformation of attributes associated with the client data 330 in accordance with the customized data schema A 320. Client training data A 335 has the same data content as client data A 330 or a subset of client data A 330, but follows a different data schema. Specifically, client data A 330 follows the client defined data schema, whereas client training data A 335 follows the customized data schema A 320, which is based on a common meta data schema 310.

Similarly, the second client can convert client data B 340 to client training data B 345 that follows customized data schema B 325. Client training data B 345 may have the same data content as client data B 340 or a subset of client data B 340, but follows a different data schema. Specifically, client data B 340 follows client defined data schema, whereas client training data B 345 follows customized data schema B 325, which is based on the common meta data schema 310.

For example, the meta data schema 310 may include a user identifier, contexts, and a label. A client may customize the meta data schema 310 to indicate that the user identifier is the phone number in client data A 330 and also indicate that the value type is a string. Moreover, the client may indicate that the label is the fraud in client data A 330 and the value type is a boolean type. In addition, the context in the meta data schema 310 may further include a Uniform Resource Locator (URL), an application identifier, a cost, a voting, a good identifier, etc. The client may customize the URL to be a visiting_URL whose value type is a string, the application identifier to be an app_ios_id whose value type is a string, the cost to be a cost whose value type is an integer, the voting to be a voting whose value type is enum, the good identifier to be phone_id whose value type is a string, etc.

The following is an exemplary excerpt of a raw data file corresponding to client data A 330.
“phone#”: “123123123123”, “visiting_url”: http://www.weibo.com/, “app_ios_id”: “AFX34CFSDA”, “fraud”: true
“phone#”: “4232fFfFFFFF”, “app_ios_id”: “KFF3123FFS”, “fraud”: false

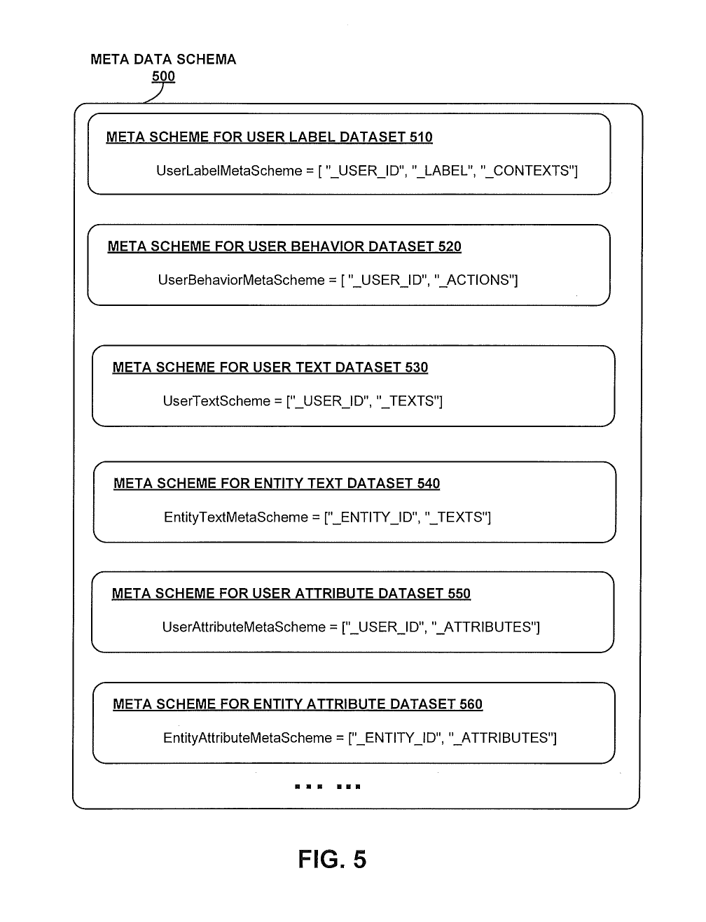

The following exemplary codes can be used to convert the raw data file corresponding to client data A 330 to follow the customized data schema A 320 that is derived from the meta data schema 310, which includes the user identifier, contexts, and a label. Here, the User_Defined_Scheme is customized data schema A 320 derived from the parent schema, which is the meta data schema 310. The meta data schemas supported by the service builder web application 210 are described in relation to FIG. 5 in upcoming sections.

```
  User_Defined_Scheme
  By default
      {
          ″parentType″: ″_USER_ID″,
          ″value″: ″phone#″,
      },
      {
          ″parentType″: ″_LABEL″,
          ″value″: ″fraud″,
      }, {
            ″parentType″: ″_CONTEXTS″,
            ″value″:  [″visiting_url″,  ″app_ios_id″,
″cost″, ″voting″]
        }, {
            ″parent Type″: ″ _URL″,
            ″value″: ″visiting_url″,
        }, {
            ″parentType″: ″_APP_ID″,
            ″value″: ″app_ios_id″,
        }, {
            ″value″: ″cost″,
            ″parentType″: ″Cost″,
        }, {
            ″parentType″: ″Voting″
            ″value″: ″voting″,
        }
  User_Defined_semanticType
  {
    ″semanticType″: ″Cost″,
    ″parentType″: ″_INT″
  }
  {
    ″semanticType″: ″Voting″
    ″parentType″: ″_ENUM″
    ″value″: [″good″, ″ok″ , ″bad″]
  }
```

Note that the meta data schema inherently incorporates the key performance indicators (KPIs) of the business clients. In the above example, the KPI may be to optimize the number of positive labels. Thus, the KPIs are often encoded into the meta data schemas. Likewise, data features can be encoded into the meta data schemas as well.

B. Meta Training Component

Referring now to FIG. 3B, a block diagram illustrating an exemplary meta training component 350, which provides machine learning services according to embodiments of the present disclosure, is shown. Specifically, the model training logic A 370 (referred to as model training logic 220 of FIG. 2 and sometimes referred to as a “training component”) is automatically generated from the meta training component 350. Likewise, model training logic B 375 is also automatically generated from the meta training component 350. Thus, model training logic A 370 and model training logic B 375 share the same implementation algorithms. Each model training logic 370 and 375 may constitute a binary file that is deployed onto a client's system.

Also, each model training logic 370 and 375 is compatible to a specific set of training data that follows a particular customized data schema. For example, model training logic A 370 is adapted to use client training data A 335, which follows customized data schema A 320 as shown in FIG. 3A. Model training logic B 375 is adapted to use client training data B 345, which follows the customized data schema B 325 also shown in FIG. 3A. Accordingly, model training logic A 370 cannot use client training data B 345 to train models, because it follows a different customized data schema, namely the customized data schema B 325. Similarly, model training logic B 375 cannot use client training data A 335 to train models, because it follows the customized data schema A 320. This design feature enhances the security of the machine learning system according to the embodiments of the present disclosure, yet the engineering cost for generating client-specific model training logic binary file is minimal.

Although not shown, in some embodiments, meta training component 350 is a standalone component from service builder web application 210; while in some embodiments, meta training component 350 can be maintained by service builder web application 210, which can also automatically generate model training logic units that are specific to each customized data schema. In other embodiments, model training logic A 370 and model training logic B 375 can be built via a standalone process, e.g., via a scheduled daily job that automatically builds model training logic units.

C. Trainer Generator

FIG. 3C is a block diagram illustrating an exemplary trainer generator for providing machine learning services according to embodiments of the present disclosure. As previously described above and illustrated in FIG. 3A, the service builder web application 210 maintains one or more meta data schema 310 and provides an online interface for business clients to customize meta data schema 310 and generate customized data schemas, such as customized data schema A 320 and customized data schema B 325. The service builder web application 210 further transmits the generated customizer data schemas to a trainer generator 380.

Moreover, based on the customized data schema received from service builder web application 210, the trainer generator 380 may access meta training component 350 and generate model training logic that is specific to the customized data schema. For example, based on customized data schema A 320, the trainer generator 380 may access meta training component 350 to automatically generate model training logic A 370 that is compatible with customized data schema A 320. The source code associated with the automatically generated model training logic A 370 is then built and compiled into a binary file, which will be deployed to the first client's system, and can use client training data A 335 of FIG. 3A to train models.

Similarly, as another example, based on customized data schema B 325, the trainer generator 380 accesses meta training component 350 to automatically generate model training logic B 375 that is compatible with customized data schema B 325. The source code associated with the automatically generated model training logic B 375 is then built and compiled into a binary file, which will be deployed to the second client's system, and can use client training data B 345 of FIG. 3A to train models. Hence, the trainer generator 380 enables the generation of specific model training logic 370/375 for each client, based on the customized schema specific to that client.

The generation of the model training logic 370 or 375 can be conducted in a periodic or an aperiodic generation scheme. For example, in accordance with an aperiodic scheme, the generation of the model training logic can be evoked by service builder web application 210 whenever a new customized data schema is created. In accordance with a periodic generation scheme, service builder web application 210 periodically pushes a set of customized data schema to trainer generator 380.

Note that meta training component 350 generally uses the same algorithm for the same meta data schema. Thus, the trainer generator 380 will determine a particular meta data schema from which the received customized data schema is derived, and then access the meta training component 350 or the portion of meta training component 350 that is corresponding to the particular meta data schema. Therefore, the capacity of the meta training component 350 is independent from the number of business clients or the degree of diversity in the diversified data used by different business clients. The capacity of meta training component 350 is dependent, and perhaps solely dependent, in one embodiment, upon the number of meta data schemas that the machine learning system supports. Such design feature of the meta training component 350 dramatically reduces the engineering cost of the machine learning system. Stated differently, different industries of business clients often share the same meta data schemas. Meta training component 350 predefines multiple meta data schemas, so it could support many diversified business clients without the additional engineering of the whole customized machine learning systems.

In order to train models, the trainer generator 380 will automatically perform unsupervised feature learning from client training data. Moreover, the trainer generator 380 also does feature learning on all of the heterogeneous data such as featuring learning associated with one data type may be useful for feature learning associated with another (and perhaps different) data type. As such, the machine learning system according to embodiments of the present disclosure can fully leverage the learning across diversified data without compromising the data security of the system.

Each feature can be described as a vector of real numbers that project an element of the meta data schema such as an entity or an object into a d-dimensional space. By doing such projection, the machine learning system can easily define the relationship (e.g., similarities or differences) between different entities, objects, etc., which can be more useful for the model training process compared to the client's raw dataset. The learned features can be used to optimize the KPIs that are encoded in the models generated by the trainer generator 380 by maximizing the probabilities of the corresponding objective functions involving the KPIs. The learned features can also be projected to sub-spaces to determine whether the corresponding entities/objects are related to the same set of concepts and thus be grouped together.

Also, in some embodiments, a business client can select different meta schemas to generate different customized data schemas and convert client data to different sets of client training data. In such cases, the meta training component 350 will generate different model training logic units for the different customized data schemas that follow different meta data schemas. Therefore, it is possible for the machine learning system to generate different models for the same business client with the same data set. For example, with the same data set, one customized data schema may optimize the number of times an advertisement is clicked by users, whereas another customized data schema may optimize the positive fraud count. Thus, the meta training component 350 will generate two different models to optimize these two different goals. Specifically, one model may be used to predict whether a user may click an advertisement and another model may be used to predict whether the user click is a fraudulent click.

D. Serving Component

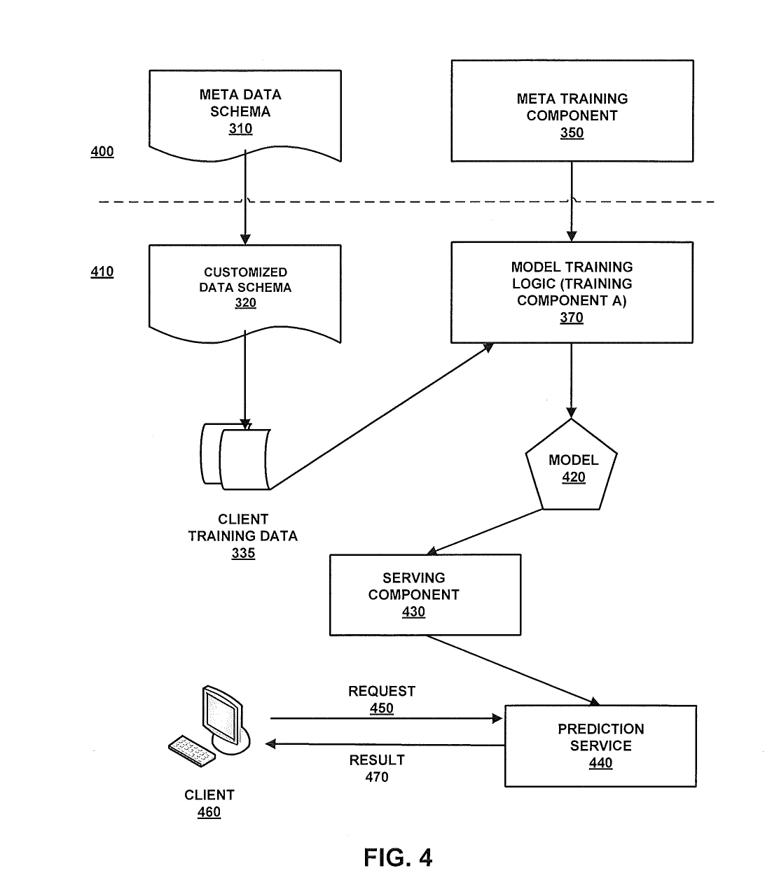

The machine learning service system according to embodiments of the present disclosure also includes a serving component 410 of FIG. 4 that services requests from business clients. The automatically generated training models are loaded by the serving component 410. Based on the received requests, the serving component 410 provides services to the client system.

### Machine Learning Service Deployment

FIG. 4 is a block diagram illustrating an exemplary view of machine learning service deployment between a client environment 400 and a machine learning service provider 410 according to embodiments of the present disclosure.

In FIG. 4, meta data schema 310 and meta training component 350 are deployed on the computing device of the machine learning service provider 410. Meta training component 350 and meta data schema 310 are compatible with each other. Thus, each meta data schema 310 that is supported by the machine learning service system corresponds to a meta training component 350 or a portion of meta training component 350.

Moreover, after a business client customizes meta data schema 310, the machine learning service system generates customized data schema (e.g., customized data schema 320), and also automatically generates a corresponding training component (e.g., model training logic A 370) based on meta training component 350. Both customized data schema 320 and the model training logic A 370 are deployed on the computing device in the client environment 410. Further, customized data schema 320 and the model training logic A 370 are compatible with each other.

Also, the business client will convert its proprietary data to client training data (e.g., client training data A 335), which follows customized data schema 320 that is derived from meta data schema 310. On the other hand, the model training logic A 370 will generate a related model 420 based on the client training data 335. The generated model 420 subsequently can be used by a serving component 430 that is also deployed on the computing device of the client.

Serving component 430 provides a prediction servicing 440 which receives a request 450 from the client 460. For example, request 450 may be a prediction of the label, which is not included in client training data 335. Serving component 430 can load model 420 and apply it to request 450 to predict the label, and return result 470 to client 460.

### Meta Data Schemas

FIG. 5 is a block diagram illustrating exemplary meta data schemas according to embodiments of the present disclosure. The meta data schemas define the capabilities of the machine learning system. Specifically, the meta data schemas set a boundary as to what types of data the machine learning system can support. For example, if none of the meta data schemas define an image as a semantic type, then the machine learning system will not support image recognition or any other image processing related functions. However, most business clients can use one or more meta data schemas to generate thousands or even millions of meta data schemas that fit their business needs.

As illustrated in FIG. 5, meta data schemas 500 include, but are not limited to or restricted to, a first meta scheme for user label dataset 510, a second meta scheme for user behavior dataset 520, a third meta scheme for user text dataset 530, a fourth meta scheme for entity text dataset 540, a fifth meta scheme for user attribute dataset 550, and/or a sixth meta scheme for entity attribute dataset 560. These meta schemes provide a systematic and consistent way to describe associated data.

Specifically, the first meta scheme 510 may include a plurality of groups of semantic data attributes, namely a user identifier, a label, and contexts as an example.
UserLabelMetaScheme=[“_USER_ID”, “_LABEL”, “_CONTEXTS”]
   The first meta scheme represents that a particular user identified by the user identifier _USER_ID having the particular label _LABEL under the particular contexts _CONTEXTS. Here, the label can be specified as, for example, an advertisement click, a fraudulent click, a purchase, a view of a video clip/stream, etc.

The second meta scheme 520 includes a user identifier and a set of actions.
UserBehaviorMetaScheme=[“_USER_ID”, “_ACTIONS”]
   The second meta scheme 520 represents that a particular user identified by the user identifier _USER_ID performs a particular set of actions _ACTIONS in sequence. For example, a user may view a TV show, read an electronic book chapter, play a game, call for a taxi, and purchase from a restaurant for food delivery. This sequence of actions by the user can be described using the user behavior meta scheme.

The third meta scheme 530 includes a user identifier and a set of texts.
UserTextScheme=[“_USER_ID”, “_TEXTS”]
   Herein, the third meta scheme 530 represents that a particular user identified by the user identifier _USER_ID generates a particular set of texts _TEXTS. For example, a user may input some online review comments. Such comments by the user can be described using the user text meta scheme.

The fourth meta scheme 540 includes an entity identifier and a set of texts.
EntityTextMetaScheme=[“_ENTITY_ID”, “_TEXTS”]
   Herein, the fourth meta scheme 540 represents a particular entity identified by the entity identifier _ENTITY_ID is associated with a particular set of texts _TEXTS. Here, the entities may be associated with products, goods, places, establishments, etc. The texts can be, for example, the name of the entity, the description of the entity, a snippet of the content of the entity, the entire content of the entity, etc.

The fifth meta scheme 550 includes a user identifier and a set of attributes.
UserAttributeMetaScheme=[“_USER_ID”, “_ATTRIBUTES”]
   Herein, the fifth meta scheme 550 represents that a particular user identified by the user identifier _USER_ID can be described by a particular set of attributes _ATTRIBUTES. For example, the attributes may be the country, the age, the gender, or any demographic attributes of the particular user. In addition, the attributes may be any user device related attributes, e.g., the model of the user's cellular phone, the type of the browser that the user uses, etc.

The sixth meta scheme 560 includes an entity identifier and a set of attributes.
EntityAttributeMetaScheme=[“_ENTITY_ID”, “_ATTRIBUTES”]
   Herein, the sixth meta scheme 560 represents that a particular entity identified by the entity identifier _ENTITY_ID can be described by a particular set of attributes _ATTRIBUTES. Here, the attributes may be categorical information associated with the particular entity. For example, the attributes for a restaurant may be the cuisine associated with the restaurant, or tags that describe the restaurant such as “family friendly,” “romantic,” “casual,” etc.

### Reinforcement Among Meta Data Schemas

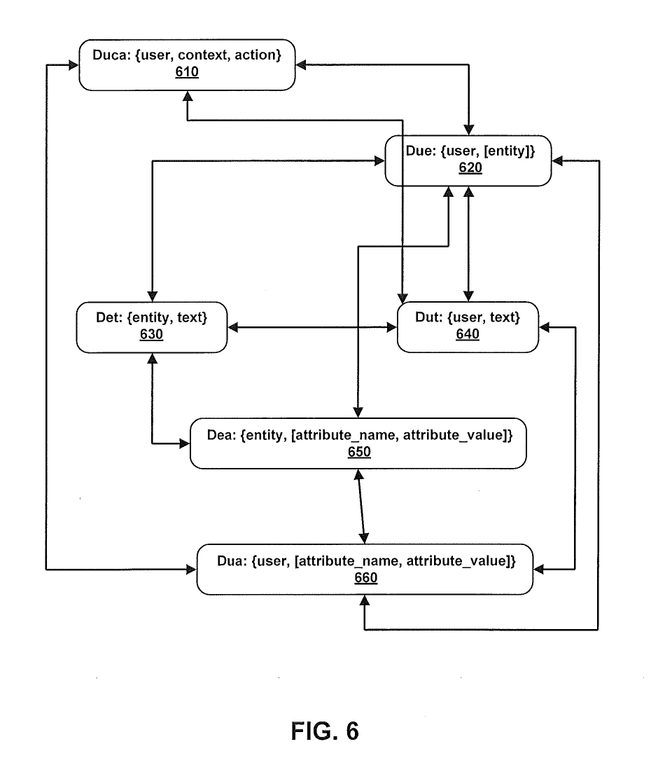

FIG. 6 is a block diagram illustrating an example of how meta data schemas reinforce each other during the machine learning process according to embodiments of the present disclosure. Models that learn a particular type of meta data schema can help the learning of other model training logic units that train models for data schemas derived from other types of meta data schemas as long as the other types of meta data schemas share at least one common element as the particular type of meta data schema.

Specifically, FIG. 6 includes the six types of meta data schema corresponding to meta data schemes 500-560 of FIG. 5 as described in the section above, e.g., meta scheme for user label dataset Duca: {user, context, action} 610, meta scheme for user behavior dataset Due: {user, [entity]} 620, meta scheme for entity text dataset Det: {entity, text} 630, meta scheme for user text dataset Dut: {user, text} 640, meta scheme for entity attribute dataset Dea: {entity, [attribute_name, attribute_value]} 650, meta scheme for user attribute dataset Dua: {user, [attribute_name, attribute_value]} 660.

As illustrated in FIG. 6, the meta scheme for user label dataset Duca 610 can be reinforced by meta scheme for user behavior dataset Due 620, the meta scheme for user text dataset Dut 640, and the meta scheme for user attribute dataset Dua 660. The meta scheme for user behavior dataset Due 620 can be reinforced by the meta scheme for user label dataset Duca 610, the meta scheme for entity text dataset Det 630, the meta scheme for user text dataset Dut 640, the meta scheme for entity attribute dataset Dea 650, and the meta scheme for user attribute dataset Dua 660. The meta scheme for entity text dataset Det 630 can be reinforced by meta scheme for user behavior dataset Due 620, the meta scheme for user text dataset Dut 640, and the meta scheme for entity attribute dataset Dea 650. The meta scheme for user text dataset Dut 640 can be reinforced by the meta scheme for user label dataset Duca 610, the meta scheme for user behavior dataset Due 620, the meta scheme for entity text dataset Det 630, and the meta scheme for user attribute dataset Dua 660. The meta scheme for entity attribute dataset Dea 650 can be reinforced by the meta scheme for user behavior dataset Due 620, the meta scheme for entity text dataset Det 630, and the meta scheme for user attribute dataset Dua 660. The meta scheme for user attribute dataset Dua 660 can be reinforced by the meta scheme for user label dataset Duca 610, the meta scheme for user behavior dataset Due 620, the meta scheme for user text dataset Dut 640, and the meta scheme for entity attribute dataset Dea 650.

### Process of Providing Customized Machine Learning Services

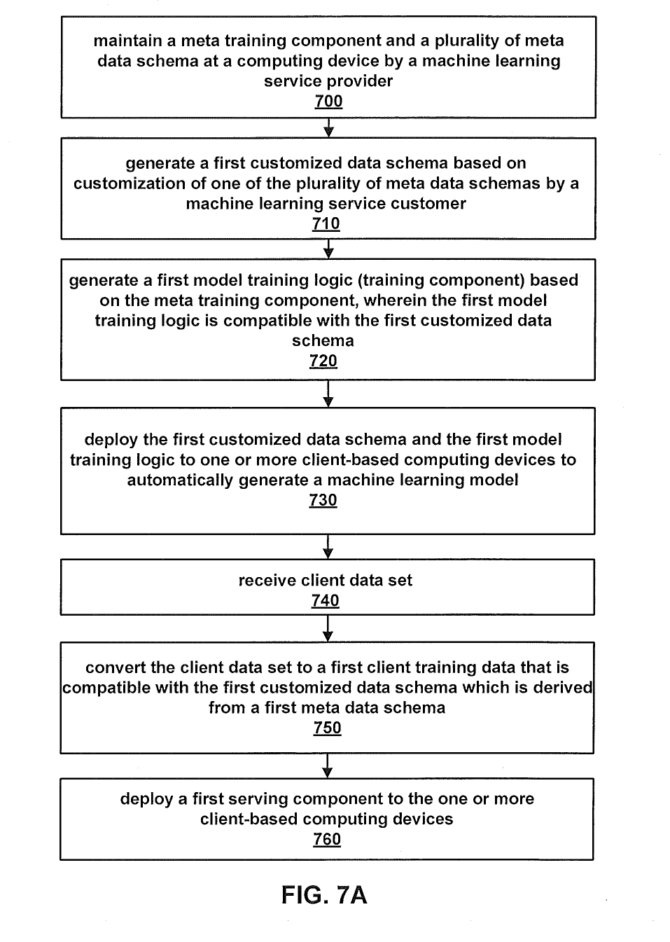

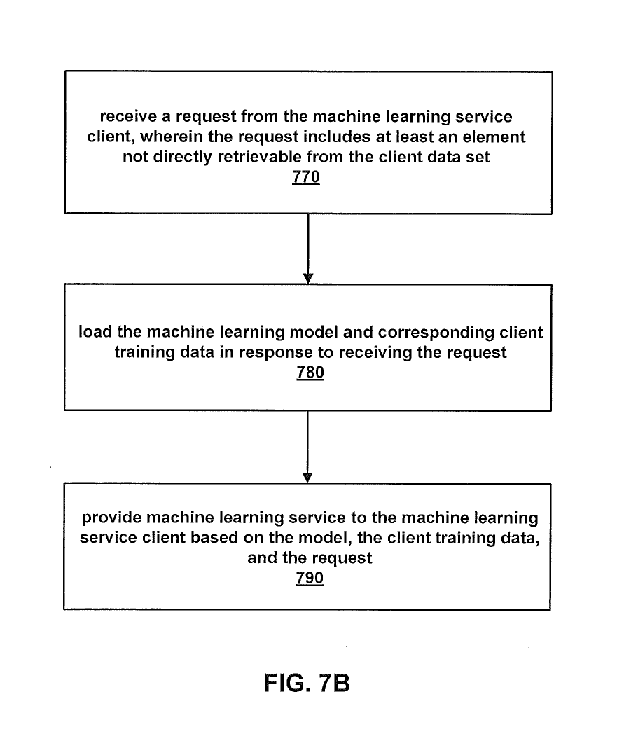

FIGS. 7A-7B are flowcharts illustrating an exemplary process for providing customized machine learning services according to embodiments of the present disclosure.

During operations, a computing device by a machine learning service provider maintains a meta training component and a plurality of meta data schemas (operation 700). The computing device also generates a first customized data schema based on customization of one of the plurality of meta data schemas by a machine learning service client (operation 710). In addition, the computing device generates a first model training logic based on the meta training component, wherein the first model training logic is compatible with the first customized data schema (operation 720). Next, the computing device deploys the first customized data schema and the first model training logic to one or more client-based computing devices to automatically generate a machine learning model (operation 730).

Furthermore, in some embodiments, the computing device receives a client data set (operation 740), and converts the client data set to a first client training data that is compatible with the first customized data schema which is derived from a first meta data schema (operation 750).

In some embodiments, the computing device also deploys a first serving component to the one or more client-based computing devices (operation 760). FIG. 7B is a flowchart illustrating an exemplary process for the first serving component to provide customized machine learning services according to embodiments of the present disclosure. Specifically, the first serving component can receive a request from the machine learning service client, wherein the request includes at least an element not directly retrievable from the client data set (operation 770). Then, the first serving component loads the machine learning model and corresponding client training data in response to receiving the request (operation 780). Thereafter, the first serving component provides machine learning service to the machine learning service client based on the model, the client training data, and the request (operation 790).

In some embodiments, the machine learning model is used to optimize a particular key performance indicator (KPI). Here, KPI generally indicates a type of performance measurement that evaluates an organization or an activity in which the organization engages. The particular key performance indicator (KPI) may include one or more of: a sales growth, sales bookings, a quote to close ratio, a sales target, an average profit margin, an average purchase value, a return on investment (ROI), keyword performance, an email marketing engagement level, a social sentiment level, average call handling time, a client satisfaction level, and a call resolution rate.

In some embodiments, the plurality of meta data schemas may include one or more of: a meta data schema for user label dataset; a meta data schema for user behavior dataset; a meta data schema for user text dataset; a meta data schema for entity text dataset; a meta data schema for user attribute dataset; and a meta data schema for entity attribute dataset. Specifically, the meta data schema for user label dataset includes a user identifier, a label, and contexts. The meta data schema for user behavior dataset includes a user identifier and a set of actions. The meta data schema for user text dataset includes a user identifier and a set of texts. The meta data schema for entity text dataset includes an entity identifier and a set of texts. The meta data schema for user attribute dataset includes a user identifier and a set of attributes. The meta data schema for entity attribute dataset includes an entity identifier and a set of attributes.

In some embodiments, the computing device further converts the client data set to a second client training data that is compatible with a second customized data schema which is derived from a second meta data schema, wherein the first meta data schema is different from the second meta data schema.

In some embodiments, the plurality of meta data schemas that share a common element reinforce each other while the first model training logic generating the machine learning model.

In some embodiments, the meta training component can select a subset of the plurality of meta data schemas corresponding to the machine learning service client. Moreover, the meta training component also extracts one or more features from the client data set, and improves a key performance indicator (KM) specific to the machine learning service client based on the extracted one or more features.

In some embodiments, the computing device further deploys a second serving component to the one or more client-based computing devices, wherein the second serving component automatically synchronizes with the first serving component.

In some embodiments, the client data set includes sensitive or confidential data and is not used by the machine learning service provider for model training. Rather, the first client training data does not include sensitive or confidential data and is used by the machine learning service provider for model training

In some embodiments, the computing device further generates a second model training logic based on the meta training component. In particular, the second model training logic is compatible with a second customized data schema which is derived from one of the plurality of meta data schemas. Moreover, the second customized data schema is different from the first customized data schema. Note that the second model training logic is incompatible with the first customized data schema; and, the first model training logic is incompatible with the second customized data schema.

### System of Providing Customized Machine Learning Services

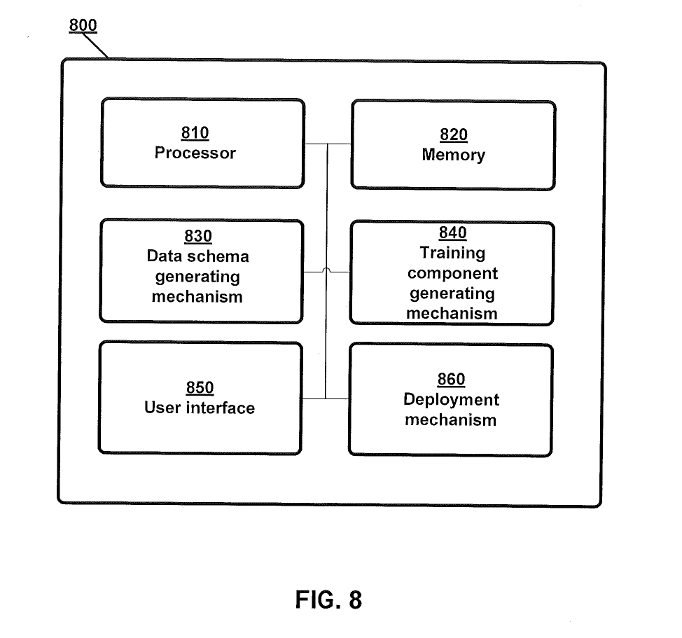

FIG. 8 is a block diagram illustrating an exemplary computing device for providing customized machine learning services according to embodiments of the present disclosure. Configured as a machine learning service provider system, the computing device 800 includes at least one or more processors 810 capable of processing computing instructions, and a memory 820 capable of storing instructions and data. Moreover, machine learning service provider system 800 further includes a data schema generating mechanism 830, a training component generating mechanism 840, a user interface 850, and a deployment mechanism 860, all of which are in communication with processor 810 and/or memory 820 in machine learning service provider system 800.

Processor 810 can include one or more microprocessors and/or network processors.

Memory 820 can include storage components, such as, Dynamic Random Access Memory (DRAM), Static Random Access Memory (SRAM), etc. Specifically, memory 820 can maintain a meta training component and a plurality of meta data schemas for machine learning service provider system 800. Different meta data schemas may be used to describe different types of data, where new meta data schemes may be added to handle new types of data.

The plurality of meta data schemas may include, but are not limited to, a meta data schema for user label dataset; a meta data schema for user behavior dataset; a meta data schema for user text dataset; a meta data schema for entity text dataset; a meta data schema for user attribute dataset; and a meta data schema for entity attribute dataset. The meta data schema for user label dataset may include a user identifier, a label, and contexts. The meta data schema for user behavior dataset may include a user identifier and a set of actions. The meta data schema for user text dataset may include a user identifier and a set of texts. The meta data schema for entity text dataset may include an entity identifier and a set of texts. The meta data schema for user attribute dataset may include a user identifier and a set of attributes. The meta data schema for entity attribute dataset may include an entity identifier and a set of attributes.

Data schema generating mechanism 830 generally generates customized data schemas that are derived from one or more meta data schemas. Specifically, data schema generating mechanism 830 can generate a first customized data schema based on customization of one of the plurality of meta data schemas by a machine learning service client. As an illustrative example, where the meta schema is {entity, text}, the client data is about titles of books: <book_id, book_title>. Then, the ‘entity’ is ‘book_id’, and the ‘text’ is ‘book_title’

Training component generating mechanism 840 generally generates training components (model training logic) specific to customized data schemas based on a meta training component. In particular, training component generating mechanism 840 can generate a first model training logic based on the meta training component. Here, the first model training logic is compatible with the first customized data schema.

In some embodiments, training component generating mechanism 840 can generate a second model training logic based on the meta training component. Here, the second model training logic is compatible with a second customized data schema which is derived from one of the plurality of meta data schemas. The second customized data schema is different from the first customized data schema. Also, the second model training logic is incompatible with the first customized data schema; and, the first model training logic is incompatible with the second customized data schema.

In some embodiments, the plurality of meta data schemas that share a common element reinforce each other while the first model training logic generating the machine learning model.

Moreover, the meta training component can select a subset of the plurality of meta data schemas corresponding to the machine learning service client. Also, the meta training component can extract one or more features from the client data set; and improve a key performance indicator (KPI) specific to the machine learning service client based on the extracted one or more features. Stated differently, the machine learning algorithm uses training data to train models to optimize KPI.

User interface 850 allows a machine learning service client to select one or more meta data schemas and input customization of the meta data schemas in order to generate the customized data schemas. User interface 850 can also be used by the machine learning service provider and the machine learning service client for other communication purposes, for example, communicating a service request or service response, communicating a training model, communicating client training data, etc. Specifically, user interface 850 may be used to receive a client data set, and convert the client data set to a first client training data that is compatible with the first customized data schema which is derived from a first meta data schema. The client data set can also be converted to a second client training data that is compatible with a second customized data schema which is derived from a second meta data schema, whereas the first meta data schema is different from the second meta data schema.

In some embodiments, the client data set includes sensitive or confidential data and is not used directed by the machine learning service provider for model training, whereas the first client training data does not include sensitive or confidential data and is used by the machine learning service provider for model training.

Also, user interface 850 may be used to receive a request from the machine learning service client. The request includes at least an element not directly retrievable from the client data set.

Deploying mechanism 860 generally deploys a component or module by a machine learning service provider to a machine learning service client. For example, deploying mechanism 860 may deploy the first customized data schema and the first model training logic to one or more client devices to automatically generate a machine learning model. The machine learning model can be used to optimize a particular key performance indicator (KPI), KPI indicating a type of performance measurement that evaluates an organization or an activity in which the organization engages. The particular key performance indicator (KPI) may include one or more of: a sales growth, sales bookings, a quote to close ratio, a sales target, an average profit margin, an average purchase value, a return on investment (ROI), keyword performance, an email marketing engagement level, a social sentiment level, average call handling time, a client satisfaction level, and a call resolution rate.

Moreover, deployment mechanism 860 can also deploy a first serving component to the one or more client devices. The first serving component can load the machine learning model and corresponding client training data in response to receiving the request. Also, the first serving component can provide machine learning service to the machine learning service client based on the model, the client training data, and the request. In some embodiments, deploying mechanism 860 can deploy a second serving component to the one or more client devices, whereas the second serving component automatically synchronizes with the first serving component.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in the above-defined non-transitory storage medium, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A method comprising:
maintaining a meta training component and a plurality of meta data schemas at a computing device by a machine learning service provider;
generating, by the computing device, a first customized data schema based on customization of one of the plurality of meta data schemas by a machine learning service client;
generating, by the computing device, a first training component based on the meta training component, wherein the first training component is compatible with the first customized data schema; and
deploying, by the computing device, the first customized data schema and the first training component to one or more client devices to automatically generate a machine learning model.

2. The method of claim 1, further comprising:
receiving a client data set; and
converting the client data set to a first client training data that is compatible with the first customized data schema which is derived from a first meta data schema.

3. The method of claim 2, further comprising:
deploying a first serving component to the one or more client devices, wherein the first serving component:
receives a request from the machine learning service client, wherein the request includes at least an element not directly retrievable from the client data set;
loads the machine learning model and corresponding client training data in response to receiving the request; and
provides machine learning service to the machine learning service client based on the model, the client training data, and the request.

4. The method of claim 1, wherein the machine learning model is used to optimize a particular key performance indicator (KPI), KPI indicating a type of performance measurement that evaluates an organization or an activity in which the organization engages.

5. The method of claim 4, wherein the particular key performance indicator (KPI) comprises one or more of: a sales growth, sales bookings, a quote to close ratio, a sales target, an average profit margin, an average purchase value, a return on investment (ROI), keyword performance, an email marketing engagement level, a social sentiment level, average call handling time, a client satisfaction level, and a call resolution rate.

6. The method of claim 1, wherein the plurality of meta data schemas comprises:
a meta data schema for user label dataset;
a meta data schema for user behavior dataset;
a meta data schema for user text dataset;
a meta data schema for entity text dataset;
a meta data schema for user attribute dataset; and
a meta data schema for entity attribute dataset.

7. The method of claim 6, wherein the meta data schema for user label dataset comprises a user identifier, a label, and contexts.

8. The method of claim 6, wherein the meta data schema for user behavior dataset comprises a user identifier and a set of actions.

9. The method of claim 6, wherein the meta data schema for user text dataset comprises a user identifier and a set of texts.

10. The method of claim 6, wherein the meta data schema for entity text dataset comprises an entity identifier and a set of texts.

11. The method of claim 6, wherein the meta data schema for user attribute dataset comprises a user identifier and a set of attributes.

12. The method of claim 6, wherein the meta data schema for entity attribute dataset comprises an entity identifier and a set of attributes.

13. The method of claim 2, further comprising:
converting the client data set to a second client training data that is compatible with a second customized data schema which is derived from a second meta data schema, wherein the first meta data schema is different from the second meta data schema.

14. The method of claim 1, wherein the plurality of meta data schemas that share a common element reinforce each other while the first training component generating the machine learning model.

15. The method of claim 1, wherein the meta training component comprises:
selecting a subset of the plurality of meta data schemas corresponding to the machine learning service client;
extracting one or more features from the client data set; and
improving a key performance indicator (KPI) specific to the machine learning service client based on the extracted one or more features.

16. The method of claim 3, further comprising:
deploying a second serving component to the one or more client devices, wherein the second serving component automatically synchronizes with the first serving component.

17. The method of claim 2, wherein the client data set includes sensitive or confidential data and is not used directed by the machine learning service provider for model training, and wherein the first client training data does not include sensitive or confidential data and is used by the machine learning service provider for model training.

18. The method of claim 1, further comprising:
generating a second training component based on the meta training component,
wherein the second training component is compatible with a second customized data schema which is derived from one of the plurality of meta data schemas,
wherein the second customized data schema is different from the first customized data schema;
wherein the second training component is incompatible with the first customized data schema; and
wherein the first training component is incompatible with the second customized data schema.

19. A non-transitory computer readable medium comprising instructions which, when executed by one or more hardware processors, causes performance of operations comprising:
maintaining a meta training component and a plurality of meta data schemas by a machine learning service provider;
generating a first customized data schema based on customization of one of the plurality of meta data schemas by a machine learning service client;
generating a first training component based on the meta training component, wherein the first training component is compatible with the first customized data schema; and
deploying the first customized data schema and the first training component to one or more client devices to automatically generate a machine learning model.

20. A system comprising:
at least one device including a hardware processor;
the system being configured to perforin operations comprising:
maintaining a meta training component and a plurality of meta data schemas by a machine learning service provider;
generating a first customized data schema based on customization of one of the plurality of meta data schemas by a machine learning service client;
generating a first training component based on the meta training component, wherein the first training component is compatible with the first customized data schema; and
deploying the first customized data schema and the first training component to one or more client devices to automatically generate a machine learning model.
